(19) United States
(12) Patent Application Publication
(10) Pub. No.: US 2023/0206129 A1
(43) Pub. Date: Jun. 29, 2023

(54) Predicting Foot Traffic at Playgrounds

(71) Applicant: Biba Ventures Inc., Vancouver (CA)

(72) Inventors: Nis Bojin, Vancouver (CA); George Dallas, Vancouver (CA); Matthew Herbert Toner, Vancouver (CA)

(21) Appl. No.: 18/145,363

(22) Filed: Dec. 22, 2022

Related U.S. Application Data
(60) Provisional application No. 63/293,429, filed on Dec. 23, 2021.

(51) Int. Cl. G06N 20/00

(52) U.S. Cl. CPC G06N 20/00

(57) ABSTRACT

Embodiments of this disclosure (a) establish a baseline estimate of foot traffic for one or more playgrounds, the baseline estimate being a number of mobile devices running a playground game software divided by a percentage of mobile devices within the pre-defined geographic area sharing geo-location data; (b) create a training set containing playground variables collected by playground game software and other variables collected outside of the playground game software; (c) pre-process the playground variables and the other variables using a plurality of algorithms in order to derive feature columns; (d) train on the training set a plurality of stacked and unstacked learning algorithms; (e) obtain, using a stacking ensemble, a final estimate of the foot traffic for each of the one or more playgrounds. wherein the final estimate is an average of the stacked and unstacked learning algorithms; and (f) display the final estimate on a graphical user interface.

### CROSS REFERENCE TO CO-PENDING APPLICATIONS

This application claims priority to, and the benefit of, U.S. Application No. 63/293,429 filed Dec. 23, 2021.

### BACKGROUND

This disclosure is in the field of playgrounds and, more specifically, “smart playgrounds” that combine physical play activities with virtual play activities designed to work with one or more physical play structures of the playground to produce geo-specific play data.

Traditional methods of estimating foot traffic numbers for playgrounds involve people with clickers at the playground who physically count the foot traffic.

### SUMMARY

This disclosure describes embodiments of a system and method for use in estimating the number of people visiting a playground each month based on gameplay data and a number of other third party data sources. The gameplay data may come from playground game software such as, but not limited to, BIBA™ playground game software. The game software typically runs as an app on a mobile device of a user when playing on the smart playground.

In embodiments, foot traffic predictions are generated for one or more smart playgrounds. For the purposes of this disclosure, a smart playground contains one or more physical play structures containing a computer-readable identification tag. One or more users, when visiting the one or more smart playgrounds, have a mobile device executing playground game software. The mobile device reads the computer-readable identification tag of a corresponding one of the one or more playground structures and passes tag information to the playground game software. example of a smart playground is a BIBA™ smart playground.

For each mobile device running the playground game software, the playground game software tracks playground variables including location, duration and use of the one or more physical play structures, and at least one weather condition. The playground game software, through the mobile device, sends the playground variables over a network to at least one playground database including associated computer means. The at least one playground database receives and stores the playground variables and associates the playground variables with a corresponding location of the playground.

In embodiments, the method is executed by a computer and associated software (processor and non-transitory machine readable storage medium containing instructions stored thereon), the computer being in network communication with the at least one playground database and at least one third party database. The playground database stores variables associated with the playgrounds including gameplay data from playground game software. The at least one third party database stores other variables including demographic information, weather conditions, transportation routes, and statistics associated with safety; the other variables corresponding to a predefined geographic area containing a corresponding one of the one or more playgrounds.

In embodiments, non-transitory machine readable storage medium contains instructions stored thereon that, when executed by a processor:
establish a baseline estimate of foot traffic for each of the one or more playgrounds for a predetermined time interval, wherein, the baseline estimate is a number of mobile devices running a playground game software divided by a percentage of mobile devices within the pre-defined geographic area sharing geo-location data;
create a training set containing playground variables from at least one playground database and other variables from at least one third party database, data associated with the playground variables having been collected by the playground game software, data associated with the other variables having been collected outside of the playground game software;
pre-processes the playground variables and the other variables using a plurality of algorithms in order to derive feature columns;

trains, on the training set, a plurality of stacked and unstacked learning algorithms;

obtains, using a stacking ensemble, a final estimate of the foot traffic for each of the one or more playgrounds, wherein the final estimate is an average of the stacked and unstacked learning algorithms; and

displays the final estimate for the predetermined time interval on the graphical user interface. The plurality of algorithms can include at least one of a first pre-processing method including a combination of feature selection, engineering, and principal component analysis; a second pre-processing method including a combination of feature selection, engineering, and auto-encoding; and a third pre-processing method including a combination of feature selection and engineering.

### BRIEF DESCRIPTION OF THE DRAWINGS

FIG. 1 is a process flow for a prior art smart playground.

FIG. 2 is a prior art smart playground system and method, including collecting and storing data on smart playground activity. Although two mobile devices are shown, a user and a caregiver mobile device, a single mobile device may be used.

FIG. 3 is a process flow of an embodiment of a system and method of this disclosure for use in estimating playground foot traffic.

### DETAILED DESCRIPTION

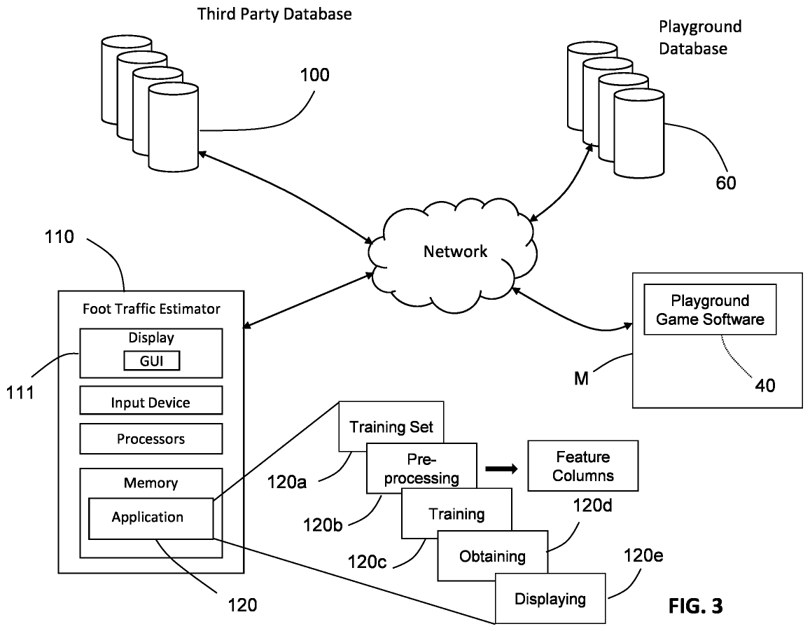

Referring first to FIG. 3, embodiments of a system and method of a foot traffic estimator 110 of this disclosure includes a software application 120 that (a) establishes a baseline estimate of foot traffic for each of one or more playgrounds, wherein, the baseline estimate is a number of mobile devices M running a playground game software 40 divided by a percentage of mobile devices within the pre-defined geographic area sharing geo-location data; (b) creates a training set 120a containing playground variables from at least one playground database 60 and containing other variables from the at least one third party database 100, data associated with the playground variables having been collected by the playground game software 40, data associated with the other variables having been collected outside of the playground game software 40; (c) pre-processes the playground variables and the other variables using a plurality of algorithms 120b in order to derive feature columns; (d) trains 120c on the training set 120a a plurality of stacked and unstacked learning algorithms; (e) obtains 120d, using a stacking ensemble, a final estimate of the foot traffic for each of the one or more playgrounds. wherein the final estimate is an average of the stacked and unstacked learning algorithms; and (f) displays 120e the final estimate on a graphical user interface 111. The method of this disclosure is executed by a computer and associated software, the computer being in network communication with the at least one playground database 60 and the at least one third party database 100 which stores the other variables. The other variables may include demographic information, weather conditions, transportation routes, and statistics associated with safety; the other variables corresponding to a predefined geographic area containing a corresponding one of the one or more playgrounds.

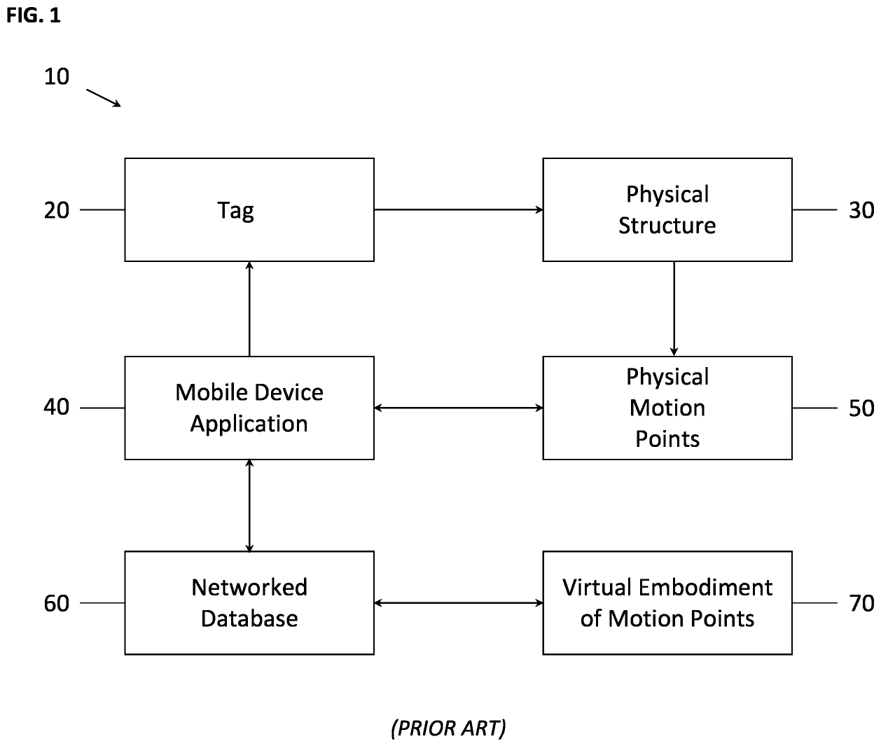

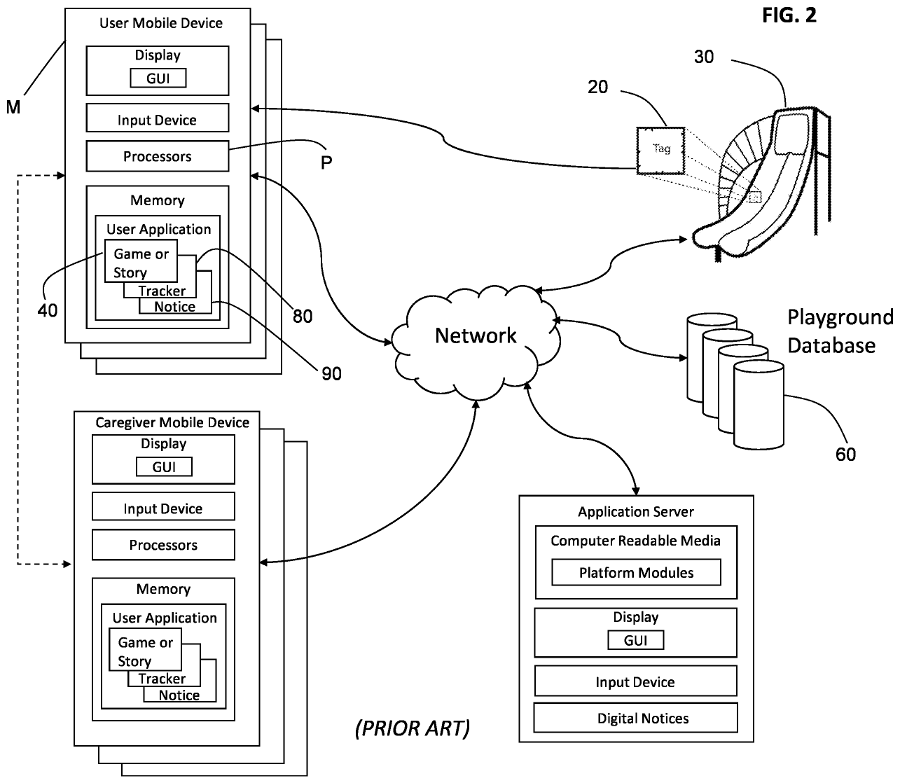

Referring now to FIGS. 1 and 2, the one or more playgrounds may contain one or more physical play structures 30 containing a computer-readable identification tag 20. One or more users, when visiting the one or more playgrounds, may have a mobile device M executing the playground game software 40. The mobile device M reads the computer-readable identification tag 20 of a corresponding one of the one or more playground structures 30 and passes tag information to the playground game software 40. For each mobile device M running the playground game software, the playground game 40 software tracks playground variables including location, duration and use of the one or more physical play structures 30, and at least one weather condition. The playground game software 40, through the mobile device M, sends the playground variables over a network to the at least one playground database 60. The at least one playground database 60 receives and stores the playground variables and associates the playground variables with a corresponding location of the playground.

The smart playground 10 includes at least one physical play structure 30 containing a computer-readable identification tag 20 and a virtual game, app or story 40 running on a mobile device M designed to work with the at least one physical play structure 30. The mobile device application 40 is in network communication with a database 60. An example of this type of playground is disclosed in U.S. Pat. No. 9,314,694 B2 to Nadel et al., the content of which is incorporated by reference herein. Other examples include playgrounds using BIBA™ mobile games marketed by PlayPower, Inc. and Biba Ventures, Inc.

As a user plays on or interacts with the physical play structure 30 physical motion points 50 are obtained and translated into a virtual embodiment of motion points 70. However, unlike other play experiences, the virtual motion points 70 are not identical to those of the physical motion points 50 because the physical play being experienced on the play structure 30 is not the same as the virtual play being executed by the mobile device application 40. The play of the mobile device application 40 is not intended to replicate the same play but rather motivate the user to play on or continue to play on the play structure 30. Physical play translates to user progress through the virtual game, app, or story.

A play tracker 80 tracks physical motion points 50 and virtual game progress 40p when a predetermined milestone 40m is accomplished in the virtual game 40, a digital notice 90_{N} may be sent to the user's mobile device or the user's care giver's mobile device. For a community-integrated smart playground—such as that disclosed in U.S. Pat. No. 10,953,333 B2 to Rosen et al., the content of which is incorporated by reference herein—other criterion, such as but not limited to physical presence on the playground or demographic data of the user or caregiver, may be used to issue a digital notice 90_{N}. The notice 90_{N} may include a benefit or reward offered by third party located within a predetermined radius of the playground or play structure 30. Redemption of the benefit or reward may be tracked. Some portion of the revenue connected with displaying the notice 90_{N} or redeeming the benefit may be allocated to the playground or between a curator of the notice 90_{N} and the playground. In this way, the playground provides its own revenue stream for maintenance and improvements. The geo-specific play data 80_{D} collected may also be provided to playground owners and operators for use in managing the playground and its utilization.

The physical play structure 30 may be a piece of playground equipment such as balancing equipment, climbing equipment, jumping equipment, riding equipment, sliding equipment, spinning equipment, or swinging equipment. The identification tag 20 may be a quick response code, an augmented reality card, a radio-frequency identification tag, or a near field identification tag. Movement of a user on the physical play structure 30 may be detected using an accelerometer or a global positioning system and may be translated into movement or progress within the virtual game or story 40. The virtual game, app or story 40 may be a mobile software app, with the user's mobile device M being used to track physical movement. The virtual game or story 40 represents a play activity different than the one being played on the play structure 30.

As user movement is tracked, detailed geo-specific play data 80_{D} may be collected and transformed into reports and insights that can help playground owners and operators make better choices and smarter funding decisions. Embodiments of this disclosure may be configured to collect data ranging from peak play hours to factors such as but not limited to weather and user demographics. Other data may include caregiver demographics, play pattern data relative to equipment, and chronological data.

Returning again to FIG. 3, embodiments of this disclosure use playground game sessions data collected for each playground using playground game software 40, along with a variety of other data sources including third party data sources, to estimate at the end of each month (or some other predetermined time interval) how many people visited the playground that month (or during the other predetermined time interval). The process has a number of stages which are described in this disclosure. The first stage is accessing ‘true’ foot traffic of the playgrounds in order to have a target variable to predict. The second stage is training using the different data sources used to feed as an input into the algorithm. The third stage is pre processing steps. The fourth stage involves algorithms used to train on the data.

In order to predict true (accurate) foot traffic numbers each month or, a training set is needed that has the true foot traffic numbers historically. In tests conducted by the inventors, this historical foot traffic data was collected by purchasing data from Unacast, a cell phone tracking company which collects geo located data points from a large percentage of phones used in, for example, Canada the US, European countries, and others. This dataset shall be referred to as “phone tracking data” in this disclosure). In embodiments, other cell phone tracking companies may be used alone or in combination with Unacast or the like. The data from Unacast, for example, has a unique identifier for a phone, a location where that phone was, and a time of day that the phone was at that location. This raw foot traffic data is then transformed by the system and method of this disclosure into “phone-tracked playground sessions”.

The transformation of the raw foot traffic data into phone-tracked playground sessions is accomplished using a similar method to capture playground sessions from playground game software data. If one user has at least two data points (from the Unacast or cell phone tracking dataset) within a certain radius of the playground, and the amount of time between these two points is below a predetermined threshold time value, then it is inferred that the user visited the playground. This mathematical operation can be carried out on all the data using an analytics service such as Google Cloud Dataflow or the like. The resulting dataset has the amount of phone-tracked playground sessions for each playground each month. A machine learning algorithm then tries to infer the phone-tracked playground sessions going forward.

To go from phone-tracked playground sessions to an estimate of the total number of people who visited the playground, the amount of phone-tracked playground sessions can be divided by the proportion of the population in the county where the playground is located who have their phone data being collected by Unacast or the cell phone tracking company. For instance if it is estimated there were 20 phone-tracked playground sessions at a given playground for a given month, and 10% of the population in the county where the playground is located have phones that are sending data to Unacast, the estimate for the foot traffic at the playground that month is 20 phone-tracked sessions/0.1=200 visitors to the playground.

In tests conducted by the inventors, phone-tracking playground sessions were gathered for 2,504 US playgrounds over the entirety of a historical time period (2018 and 2019). Because estimating was on a monthly basis, each row in the training set is the data around each playground each month, including the monthly phone-tracked playground sessions that is the target variable.

861 different variables were collected for each playground each month, which the machine learning algorithm used to estimate the number of phone-tracked playground sessions happening each month. About 218 of these variables for each playground came from Biba's playground game software data. These variables are found in Appendix A of this disclosure. The other 643 variables were gathered from 3rd party data sources. These data sources are:
2016 US Census (Age & Sex; Commute time & mode; Employment status; Household composition & size: Income; Birth rates; Educational attainment; School enrollment; Housing type, cost, and density; Health insurance; Disability)
News events
Open Street Maps (nearby businesses/amenities; bike routes; driving routes; walking routes
Crime rates from 2018
Election results
Holidays
Weather
Modified Koppen climate classification
States' Parks & Recreation spending

Some of the variables can be used directly, others are imputed and calculated to make new variables. For instance a variable such as the number of children under 9 around a playground, can be imputed or calculated by adding the different age groups from the census data who are 9 and under. Once the data are collected various preprocessing steps are taken before training algorithms are applied to the data.

In embodiments, the data can be pre-processed in three different ways, so as to give as much range to the different training algorithms as possible: (1) a combination of feature selection, engineering, and principal component analysis; (2) a combination of feature selection, engineering, and auto-encoding: and (3) a combination of feature selection and engineering.

1st preprocessing method. This method uses a combination of feature selection, engineering, and principal component analysis (“PCA”) components which retain 95% of the variance. This preprocessing method resulted in a dataset with 227 feature columns. An overview and description of the first preprocessing method is found in Appendix 13 of this disclosure.

2nd preprocessing method. This method uses a combination of feature selection, engineering, and auto-encoding. This preprocessing method resulted in a dataset with 125 feature columns. An overview and description of the second preprocessing method is found in Appendix C of this disclosure.

3rd preprocessing method. This method uses a combination of feature selection and engineering. This preprocessing method resulted in a dataset with 265 feature columns. An overview and description of the second preprocessing method is found in Appendix D of this disclosure.

In embodiments, once the data is preprocessed it is trained on various estimation algorithms. The final estimation algorithm used is an ensemble model, which uses multiple models and takes the average of their estimates to come up with a final estimate. This is a Stacking Ensemble with:
ExtraTrees Regressor
K-Nearest Neighbors (KNN)Regressor
Multilayer Perceptron Model-(A 5-layer deep neural network used as meta-estimator)
   Other stacks are in use too, including a Stacking Ensemble with:
ExtraTrees Regressor
XGBoost Regressor
LightGBM Regressor
CatBoost Regressor
Histogram-BasedGB Regressor
RandomForest Regressor
   Non-stacked algorithms may also be used, such as
AdaBoostRegressor
CatBoostRegressor
KNN Regressor
ExtraTrees Regressor
   These different models were tailored (and can be tailored), by tuning hyperparameters, to give the lowest error possible when estimating the phone-tracked playground sessions historically.

What is claimed:

1. Non-transitory machine readable storage medium containing instructions stored thereon that, when executed by a processor:
establish a baseline estimate of foot traffic for each of one or more playgrounds for a predetermined time interval, wherein, the baseline estimate is a number of mobile devices running a playground game software divided by a percentage of mobile devices within a pre-defined geographic area containing the one or more playgrounds and sharing geo-location data;
create a training set containing playground variables from at least one playground database and containing other variables from at least one third party database, data associated with the playground variables having been collected by the playground game software, data associated with the other variables having been collected outside of the playground game software;
pre-process the playground variables and the other variables using a plurality of algorithms in order to derive feature columns;
train, on the training set, a plurality of stacked and unstacked learning algorithms;
obtain, using a stacking ensemble, a final estimate of the foot traffic for each of the one or more playgrounds, wherein the final estimate is an average of the stacked and unstacked learning algorithms; and
display the final estimate for the predetermined time interval on a graphical user interface.

2. The non-transitory machine readable storage medium of claim 1, wherein the plurality of algorithms includes at least one of
a first pre-processing method including a combination of feature selection, engineering, and principal component analysis;
a second pre-processing method including a combination of feature selection, engineering, and auto-encoding; and
a third pre-processing method including a combination of feature selection and engineering.

3. A system comprising:
at least one playground database containing data on playground variables collected by a playground game software;
at least one third party database containing data on other variables collected outside of the playground game software; and
non-transitory machine readable storage medium containing instructions stored thereon that, when executed by a processor:
establish a baseline estimate of foot traffic for each of one or more playgrounds for a predetermined time interval, wherein, the baseline estimate is a number of mobile devices running a playground game software divided by a percentage of mobile devices within a pre-defined geographic area containing the one or more playgrounds and sharing geo-location data;
create a training set containing playground variables from at least one playground database and containing other variables from the at least one third party database, data associated with the playground variables having been collected by the playground game software, data associated with the other variables having been collected outside of the playground game software;
pre-process the playground variables and the other variables using a plurality of algorithms in order to derive feature columns;
train, on the training set, a plurality of stacked and unstacked learning algorithms;
obtain, using a stacking ensemble, a final estimate of the foot traffic for each of the one or more playgrounds, wherein the final estimate is an average of the stacked and unstacked learning algorithms; and
display the final estimate for the predetermined time interval on a graphical user interface.

4. The system of claim 3, wherein the plurality of algorithms includes at least one of
a first pre-processing method including a combination of feature selection, engineering, and principal component analysis;
a second pre-processing method including a combination of feature selection, engineering, and auto-encoding; and
a third pre-processing method including a combination of feature selection and engineering.

5. A method for estimating foot traffic at one or more playgrounds, the method, when executed by a computer and associated software:
establishes a baseline estimate of foot traffic for each of one or more playgrounds for a predetermined time interval, wherein, the baseline estimate is a number of mobile devices running a playground game software divided by a percentage of mobile devices within a pre-defined geographic area containing the one or more playgrounds and sharing geo-location data;
creates a training set containing playground variables from at least one playground database and containing other variables from the at least one third party database, data associated with the playground variables having been collected by the playground game software, data associated with the other variables having been collected outside of the playground game software;
pre-processes the playground variables and the other variables using a plurality of algorithms in order to derive feature columns;
trains, on the training set, a plurality of stacked and unstacked learning algorithms;
obtains, using a stacking ensemble, a final estimate of the foot traffic for each of the one or more playgrounds, wherein the final estimate is an average of the stacked and unstacked learning algorithms; and
displays the final estimate for the predetermined time interval on a graphical user interface.

6. The method of claim 5, wherein the plurality of algorithms includes at least one of
a first pre-processing method including a combination of feature selection, engineering, and principal component analysis;
a second pre-processing method including a combination of feature selection, engineering, and auto-encoding; and
a third pre-processing method including a combination of feature selection and engineering.
